(19) United States
(12) Patent Application Publication
(10) Pub. No.: US 2015/0146124 A1
(43) Pub. Date: May 28, 2015

(54) LIQUID CRYSTAL DISPLAY AND MANUFACTURING METHOD THEREOF

(71) Applicant: SAMSUNG DISPLAY CO., LTD., Yongin-City (KR)

(72) Inventors: JANG-IL KIM, Asan-si (KR); SEI-YONG PARK, Suwon-si (KR); YEO GEON YOON, Suwon-si (KR); SUNG HEE HONG, Hwaseong-si (KR)

(21) Appl. No.: 14/470,305

(22) Filed: Aug. 27, 2014

(30) Foreign Application Priority Data
Nov. 25, 2013 (KR) 10-2013-0143724

(51) Int. Cl. G02F 1/1362; G02F 1/1339; G02F 1/1368

(52) U.S. Cl. CPC G02F 1/136286; G02F 1/1368; G02F 1/1339
USPC 349/42; 438/30

(57) ABSTRACT

A manufacturing method of a liquid crystal display includes: providing a lower mother substrate including a plurality of lower panels including thin film transistors and coated with a lower alignment layer, providing an upper mother substrate including a plurality of upper panels respectively corresponding to the plurality of lower panels and coated with an upper alignment layer, forming a mother substrate assembly by forming a liquid crystal mixture layer including a liquid crystal between the lower mother substrate and the upper mother substrate and combining the lower mother substrate and the upper mother substrate, dividing each upper panel into a first region, a second region, and a third region by forming three cutting lines for each upper panel at the upper mother substrate of the mother substrate assembly; applying a voltage to the first region and the third region of the upper mother substrate that is not covered by the lower mother substrate and exposed to pretilt the liquid crystal, and irradiating light to the mother substrate assembly at a side of the upper mother substrate to harden an alignment supplement agent included in at least one of the liquid crystal mixture layer and the lower and upper alignment layers.

### CROSS-REFERENCE TO RELATED APPLICATION

This application claims priority to Korean Patent Application No. 10-2013-0143724 filed on Nov. 25, 2013, the entire disclosure of which is hereby incorporated herein by reference herein in its entirety.

### TECHNICAL FIELD

The present disclosure relates to a manufacturing method of a liquid crystal display and a liquid crystal display manufactured according thereto.

### DISCUSSION OF THE RELATED ART

A liquid crystal display (LCD) is one of the most commonly used flat panel displays, and it includes two substrates with electrodes formed thereon and a liquid crystal layer interposed between the two substrates. In the LCD, a voltage is applied to the electrodes to realign liquid crystal molecules of the liquid crystal layer to thereby regulate the transmittance of light passing through the liquid crystal layer.

To increase the response speed of the liquid crystal display, various methods for the liquid crystal molecules to be initially aligned have been proposed for providing a pretilt to the liquid crystal molecules. For example, among these initial alignment methods, in a method in which a prepolymer that is polymerized by light such as ultraviolet rays is used to provide the pretilt to liquid crystal molecules, each field generating electrode is applied with a voltage having a desired magnitude before ultraviolet ray exposure.

On the other hand, in a manufacturing method of a liquid crystal display, a thin film pattern of a multi-layered structure is formed on a mother glass through a deposition process and a photolithography process to form a plurality of display panels respectively including the thin film pattern of the multi-layered structure, and the mother glass is divided into a plurality of display panels to complete the display device.

In this manufacturing method of the liquid crystal display, when applying the voltage in the initial alignment step of the liquid crystal molecule, if the divided liquid crystal display is respectively supplied with the voltage and exposed, significant time and equipment may be required, thereby decreasing productivity.

Also, in general, in the initial alignment step of the liquid crystal molecule, voltages of the same magnitudes are applied to the gate line and the data line of a lower panel for the photo-alignment. In this case, the gate line and the data line are applied with the same voltage such that the pretilt of the liquid crystal molecule is the same in the entire region of one pixel. In contrast, to differently align the pretilt of the liquid crystal molecule for each region in one pixel, an additional input voltage may be required.

### SUMMARY

Exemplary embodiments of the present invention provide a manufacturing method of a liquid crystal display in which an upper mother substrate is divided into three regions and a resistor and a short spacer are formed at one region to generate three output voltages with two input voltages and to photo-align liquid crystal molecules to have different pretilts in each region of one pixel.

A manufacturing method of a liquid crystal display according to an exemplary embodiment of the present invention includes: providing a lower mother substrate including a plurality of lower panels including thin film transistors and coated with a lower alignment layer, providing an upper mother substrate including a plurality of upper panels respectively corresponding to the plurality of lower panels and coated with an upper alignment layer, forming a mother substrate assembly by forming a liquid crystal mixture layer including a liquid crystal between the lower mother substrate and the upper mother substrate and combining the lower mother substrate and the upper mother substrate, dividing each upper panel into a first region, a second region, and a third region by forming three cutting lines for each upper panel at the upper mother substrate of the mother substrate assembly, applying a voltage to the first region and the third region of the upper mother substrate that is not covered by the lower mother substrate and exposed to pretilt the liquid crystal, and irradiating light to the mother substrate assembly at a side of the upper mother substrate to harden an alignment supplement agent included in at least one of the liquid crystal mixture layer and the lower and upper alignment layers.

The lower panel may include a plurality of pixels, a gate driving line connected to a gate line of each pixel, a data driving line connected to a data line, and a divided voltage reference voltage driving line connected to a divided voltage reference voltage line.

Two gate driving lines may exist per lower panel, each gate driving line may be alternately connected to neighboring pixels, two data driving lines may exist per lower panel, and each data driving line may be alternately connected to the neighboring pixels.

The gate driving line and the data driving line may respectably have an expansion formed at the same side surface outside the lower panel, and a short spacer may be formed on the gate driving line expansion and the data driving line expansion.

In the lower mother substrate region corresponding to the second region of the upper mother substrate, one gate driving line, one data driving line, and the divided voltage reference voltage driving line may respectively have the expansion, and the short spacer may be formed on the gate driving line expansion, the data driving line expansion, and the divided voltage reference voltage driving line expansion.

The gate driving line and the gate driving line expansion may be connected by a resistance member, and the data driving line and the data driving line expansion may be connected by a resistance member.

The resistance member includes indium zinc oxide.

The resistance member includes at least one transistor.

The transistor may include a transistor gate line expansion formed at the lower mother substrate region corresponding to the second region of the upper mother substrate, and a connected branch electrode and a divided branch electrode in the gate driving line and the data driving line.

The transistor gate line may include a transistor gate line expansion formed at the lower mother substrate corresponding to the first region of the upper mother substrate, and a short spacer formed on the transistor gate line expansion.

The cutting of the upper mother substrate may be performed with a laser.

The voltage applied to the first region of the upper mother substrate may be transmitted to the gate driving line and the data driving line through the short spacer formed at the lower mother substrate.

A portion of the voltage transmitted to the gate driving line and the data driving line may be changed through the resistance member, and the changed voltage may be transmitted to the divided voltage reference voltage driving line through the short spacer formed at the second region of the mother substrate assembly.

The voltage applied to the third region of the upper mother substrate may be only transmitted to a common electrode of the upper mother substrate.

The voltage applied to the first region of the upper mother substrate may be about a ground voltage of 0 V, and the voltage applied to the third region of the upper mother substrate may be about 9.5 V.

In the applying of the voltage to the first region and the third region of the upper mother substrate that is not covered by the lower mother substrate and exposed to pretilt the liquid crystal, a pretilt degree of the liquid crystal in the first sub-pixel area and the second sub-pixel area of one pixel may be different.

A liquid crystal display according to an exemplary embodiment of the present invention includes a display panel. The display panel of the liquid crystal display includes: a first substrate, a gate line and a divided voltage reference voltage line disposed on the first substrate and electrically disconnected from each other, a gate insulating layer disposed on the gate line and the divided voltage reference voltage line, a semiconductor layer disposed on the gate insulating layer, a data line disposed on the semiconductor layer, a passivation layer disposed on the data line, a pixel electrode disposed on the passivation layer, a second substrate facing the first substrate, and a common electrode disposed on the second substrate. The display panel of the liquid crystal display further includes a divided voltage reference voltage line, a divided voltage reference voltage driving line, a gate driving line, and a data driving line. The gate line, the divided voltage reference voltage line, and the data line extend in one side of the first substrate to be respectively connected to the gate driving line, the divided voltage reference voltage driving line, and the data driving line. In addition, the display panel of the liquid crystal display further includes an expansion disposed at ends of the gate driving line, the divided voltage reference voltage driving line, and the data driving line, and a short spacer disposed on the expansion. The short spacer is connected with the common electrode.

Moreover, the display panel further includes an additional short spacer. The gate driving line, the divided voltage reference voltage driving line, and the data driving line may respectively have an additional expansion inside the display panel. The additional short spacer is disposed on the additional expansion. The gate driving line and the additional expansion of the gate driving line are connected by the resistance member, and the data driving line and the additional expansion of the data driving line may be connected by the resistance member.

The resistance member may include indium zinc oxide.

The first substrate in which the gate line expansion and the additional expansion, the divided voltage reference voltage line expansion and the additional expansion, and the data line expansion and the additional expansion are positioned, and the region of the second substrate region corresponding thereto, may be separated and removed.

Exemplary embodiments of the present invention separate the upper mother substrate into three regions, forms the resistor and short spacer at one region to generate three output voltages through two input voltages, and photo-aligns the liquid crystal to have the different pretilts for each region of the pixel. Consequently, exemplary embodiments of the present invention form three output voltages without three input voltages to realize the photo-alignment with the different pretilts for each region of the pixel, thereby simplifying the manufacturing process.

### BRIEF DESCRIPTION OF THE DRAWINGS

Exemplary embodiments of the present invention can be understood in more detail from the following detailed description taken in conjunction with the attached drawings in which:

FIG. 1 is a top plan view of a mother substrate assembly to explain a manufacturing method of a liquid crystal display according to an exemplary embodiment of the present invention.

FIG. 2 is an equivalent circuit diagram for one pixel of a lower panel of an exemplary embodiment of the present invention and a diagram of a connection relationship with each driving line.

FIG. 3A and FIG. 3B are views of an upper mother substrate of a mother substrate assembly according to an exemplary embodiment of the present invention.

FIG. 4 is a view of a lower mother substrate of a mother substrate assembly according to an exemplary embodiment of the present invention.

FIG. 5 is an enlarged view of a region indicated by A in FIG. 4.

FIG. 6 is an equivalent circuit diagram of one pixel of a liquid crystal display according to an exemplary embodiment of the present invention.

FIG. 7 is a layout view of one pixel of a liquid crystal display according to an exemplary embodiment of the present invention.

FIG. 8 is a cross-sectional view of the liquid crystal display of FIG. 7 taken along the line VII-VII.

FIG. 9 is a diagram of a connection relation of a gate line, a data line, and a divided voltage reference voltage line of each pixel in one lower panel of a mother substrate assembly according to an exemplary embodiment of the present invention.

FIG. 10 is a cross-sectional view of the mother substrate assembly of FIG. 1 taken along the line IX-IX.

FIG. 11 is a cross-sectional view of the mother substrate assembly of FIG. 1 taken along the line X-X.

FIG. 12 is a cross-sectional view of the mother substrate assembly of FIG. 1 taken along the line XI-XI.

FIG. 13 is a circuit diagram of a voltage applied to a divided voltage reference voltage line.

FIG. 14 is a view of a step of applying a voltage and irradiating light in a manufacturing process of a liquid crystal display according to an exemplary embodiment of the present invention.

FIG. 15 is a top plan view of a mother substrate assembly to explain a manufacturing method of a liquid crystal display according to a comparative example.

FIG. 16 is a top plan view of a mother substrate assembly to explain a manufacturing method of a liquid crystal display according to an exemplary embodiment of the present invention.

FIG. 17 is an enlarged view of a region indicated by B in FIG. 16.

FIG. 18 is a cross-sectional view of the mother substrate assembly of FIG. 16 taken along the line XVI-XVI.

FIG. 19 is a cross-sectional view of the mother substrate assembly of FIG. 1 taken along the line XVII-XVII.

### DETAILED DESCRIPTION OF EXEMPLARY EMBODIMENTS

Exemplary embodiments of the present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., may be exaggerated for clarity. Like reference numerals designate like elements throughout the specification. It will be understood that when an element such as a layer, film, region, or substrate is referred to as being “on” another element, it can be directly on the other element or intervening elements may also be present.

As used herein, the singular forms, “a”, “an”, and “the” are intended to include plural forms as well, unless the context clearly indicates otherwise.

Now, a manufacturing method of a liquid crystal display according to an exemplary embodiment of the present invention will be described with reference to accompanying drawings.

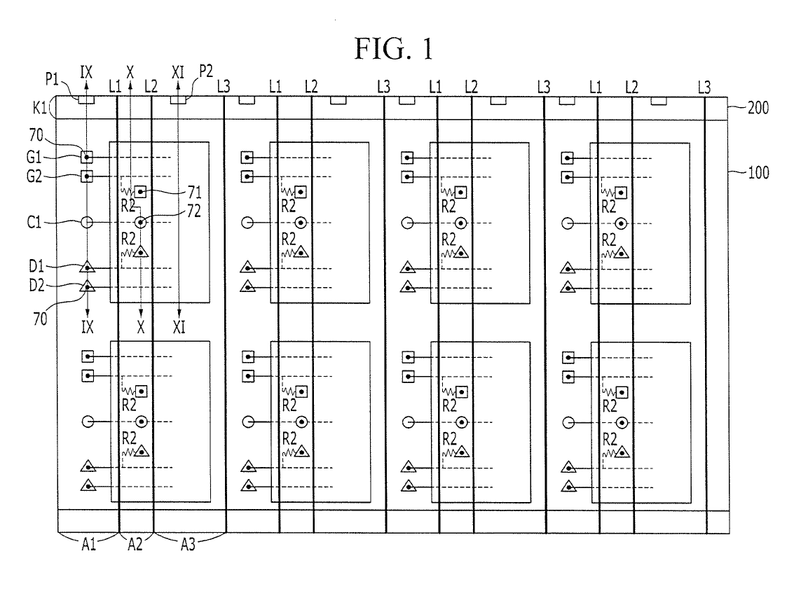

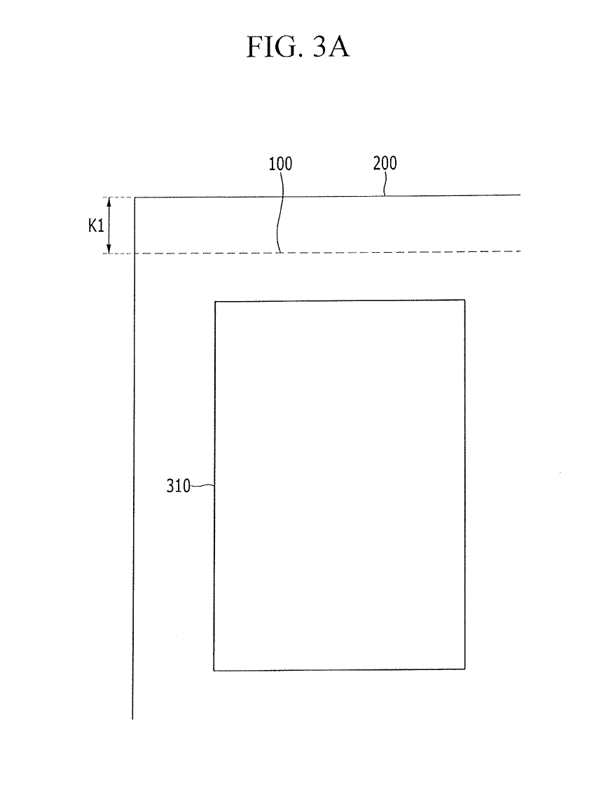

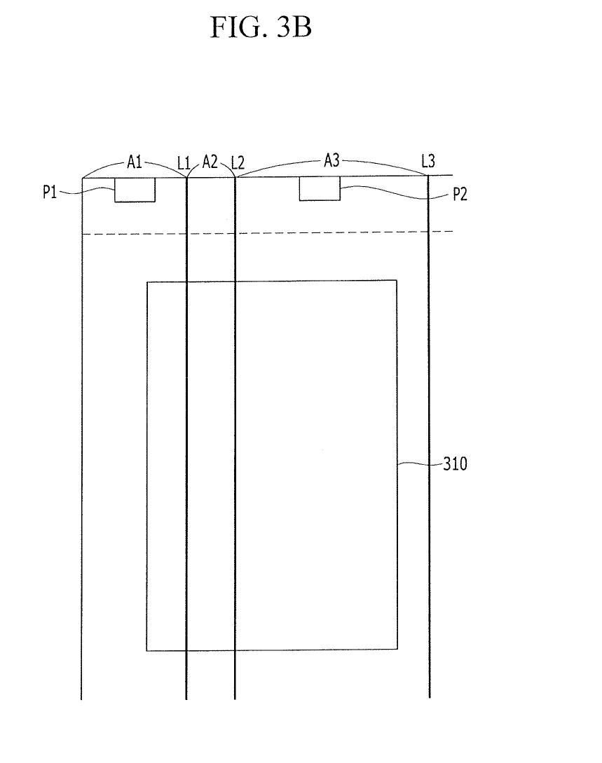

Firstly, a manufacturing method of a liquid crystal display according to an exemplary embodiment of the present invention will be described with reference to FIG. 1 and FIG. 3.

FIG. 1 is a top plan view of a mother substrate assembly to explain a manufacturing method of a liquid crystal display according to an exemplary embodiment of the present invention.

Referring to FIG. 1, a lower mother substrate 100 includes, for example, a plurality of lower panels 300. In a view of an equivalent circuit, each lower panel 300 is connected to a plurality of signal lines, and includes a plurality of pixel areas connected thereto and arranged in an approximate matrix. The lower panel 300 includes, for example, gate driving lines G1 and G2 connected to gate lines, data driving lines D1 and D2 connected to data lines, and a divided voltage reference voltage driving line C1 connected to a divided voltage reference voltage line of each pixel existing in the lower panel.

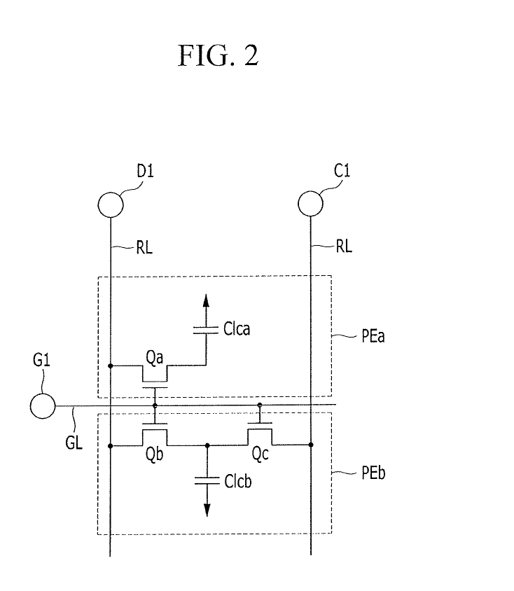

FIG. 2 is an equivalent circuit diagram for one pixel of a lower panel according to an exemplary embodiment of the present invention and a diagram of a connection relationship with each driving line. Referring to FIG. 2, in each pixel, the gate line GL is connected to the gate driving line D1, the data line DL is connected to the data driving line D1, and the divided voltage reference voltage line RL is connected to the divided voltage reference voltage driving line C1.

Again referring to FIG. 1, an expansion (indicated by, for example, a quadrangle) to be connected with an upper mother substrate is formed at each end of the gate driving lines G1 and G2. Likewise, an expansion (indicated by, for example, a triangle) is formed at each end of the data driving lines D1 and D2, and an expansion (indicated by, for example, a circle) is formed at one end of the divided voltage reference voltage driving line C1. The expansions of the gate driving lines G1 and G2, the data driving lines D1 and D2, and the divided voltage reference voltage driving line C1 are indicated by different shapes for better comprehension and ease of division, but the expansions may all have the same shape. In an embodiment, the expansion may all have, for example, a quadrangular shape.

Short spacers 70, 71, and 72 for shorting with the upper mother substrate 200 are respectively formed on the expansions of the gate driving lines G1 and G2, the data driving lines D1 and D2, and the divided voltage reference voltage driving line C1. A detailed connection relationship between the lower panel 300, and the gate driving lines G1 and G2, the data driving lines D1 and D2, and the divided voltage reference voltage driving line C1 is described later.

The expansions of the gate driving lines G1 and G2, the data driving lines D1 and D2, and the divided voltage reference voltage driving line C1 connected to one lower panel 300 on the lower mother substrate 100 exist at the same side surface of the lower panel 300. The expansions of the gate driving lines G1 and G2, the data driving lines D1 and D2, and the divided voltage reference voltage driving line C1 may exist, for example, in parallel on the same line.

FIG. 3A and FIG. 3B are views of an upper mother substrate of a mother substrate assembly according to an exemplary embodiment of the present invention. Referring to FIG. 3A and FIG. 3B, an upper mother substrate 200 includes, for example, an insulation substrate and a common electrode formed on the insulation substrate. A plurality of upper panels 310 corresponding to the lower panel 300 are formed at the upper mother substrate 200. The upper mother substrate 200 may be divided by a plurality of cutting lines L1, L2, and L3 in the manufacturing process of the liquid crystal display according to an exemplary embodiment of the present invention. In an exemplary embodiment of the present invention, the upper mother substrate 200 may be larger than the lower mother substrate 100. As the upper mother substrate 200 is larger than the lower mother substrate 100, the upper mother substrate 200 includes a region K1 at which the lower mother substrate 100 does not exist. In the region K1, voltage application portions P1 and P2 which are configured to be contacted with a probe to apply a voltage to the upper mother substrate 200 may exist.

In the manufacturing method according to an exemplary embodiment of the present invention, if the probe is contacted with the voltage application portions P1 and P2 to apply the voltage, the applied voltage is transmitted to the lower panel 300 and the upper panel 310 through the short spacers 70, 71, and 72, and is then transmitted to the gate line, the data line, and the divided voltage reference voltage line of the pixel existing inside each display panel. The liquid crystal is aligned by the applied voltage, and in this state, if light is irradiated to the upper panel, the liquid crystal is pretilted by photo-hardening of a photo-reaction material positioned between liquid crystal molecules.

Firstly, the manufacturing method of the liquid crystal display according to an exemplary embodiment of the present invention includes a step of providing the lower mother substrate in which a plurality of lower panels including the thin film transistor are formed and coated with the lower alignment layer.

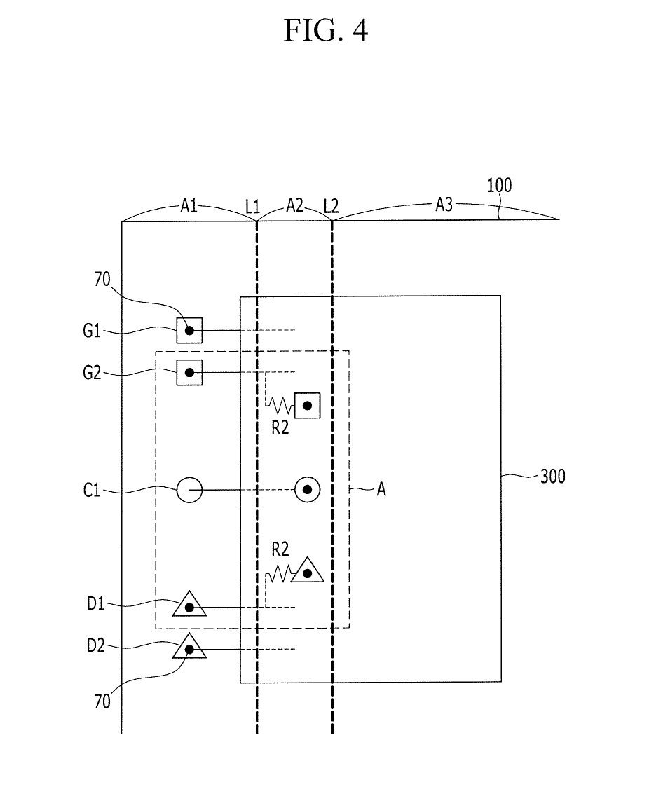

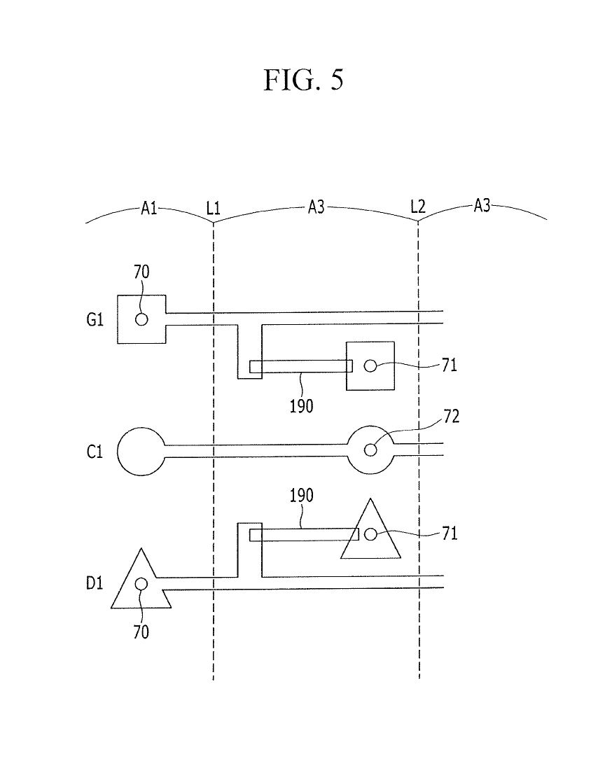

Referring to FIGS. 4 and 5, the lower mother substrate 100 including a plurality of lower panels 300 is firstly provided. FIG. 4 is a view of a lower mother substrate 100 of a mother substrate assembly according to an exemplary embodiment of the present invention. FIG. 5 is an enlarged view of a region indicated by A in FIG. 4.

In a view of the equivalent circuit, each lower panel 300 includes, for example, a plurality of signal lines and a plurality of pixel areas PXL connected thereto and arranged in a matrix shape. The plurality of signal lines include, for example, a plurality of gate lines transmitting a gate signal (referred to as “a scanning signal”) and a plurality of data lines transmitting a data voltage.

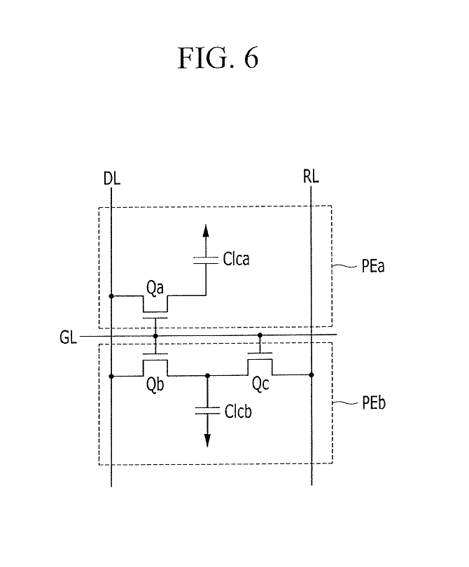

FIG. 6 is an equivalent circuit diagram of one pixel of a liquid crystal display according to an exemplary embodiment of the present invention.

Referring to FIG. 6, one pixel PX of the lower panel 300 according to the present exemplary embodiment of the present invention includes, for example, a gate line GL transmitting a gate signal, a data line DL transmitting a data signal, a plurality of signal lines including a divided voltage reference voltage line RL transmitting a divided voltage reference voltage, first, second, and third switching elements Qa, Qb, and Qc connected to the plurality of signal lines, and first and second liquid crystal capacitors Clca and Clcb.

The first and second switching elements Qa and Qb are connected to the gate line GL and the data line DL, respectively, and the third switching element Qc is connected to an output terminal of the second switching element Qb and the divided voltage reference voltage line RL.

The first switching element Qa and the second switching element Qb correspond to, for example, a three-terminal element such as a thin film transistor, and a control terminal thereof is connected to the gate line GL, an input terminal is connected to the data line DL, an output terminal of the first switching element Qa is connected to the first liquid crystal capacitor Clca, and an output terminal of the second switching element Qb is connected to the second liquid crystal capacitor Clcb and an input terminal of the third switching element Qc.

The third switching element Qc also corresponds to, for example, a three-terminal element such as a thin film transistor, and a control terminal is connected to the gate line GL, an input terminal is connected to the second liquid crystal capacitor Clcb, and an output terminal is connected to the divided voltage reference voltage line RL.

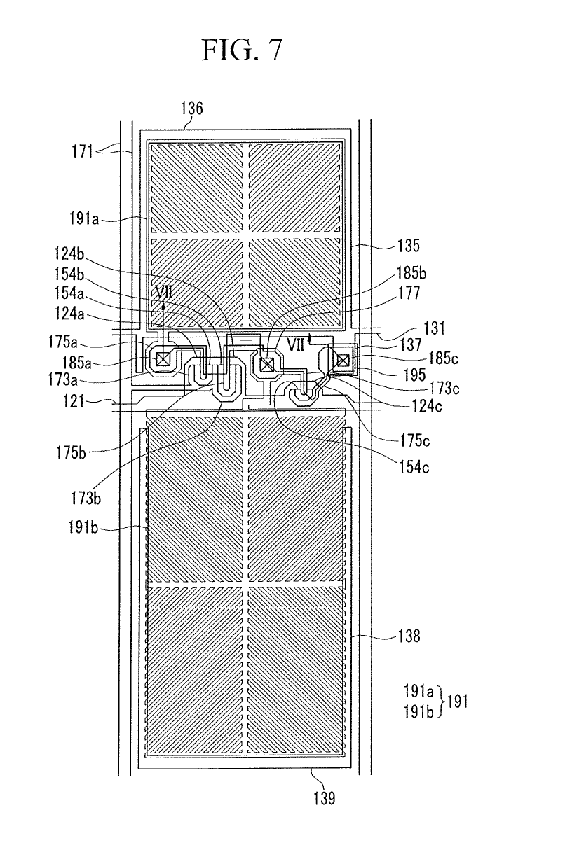

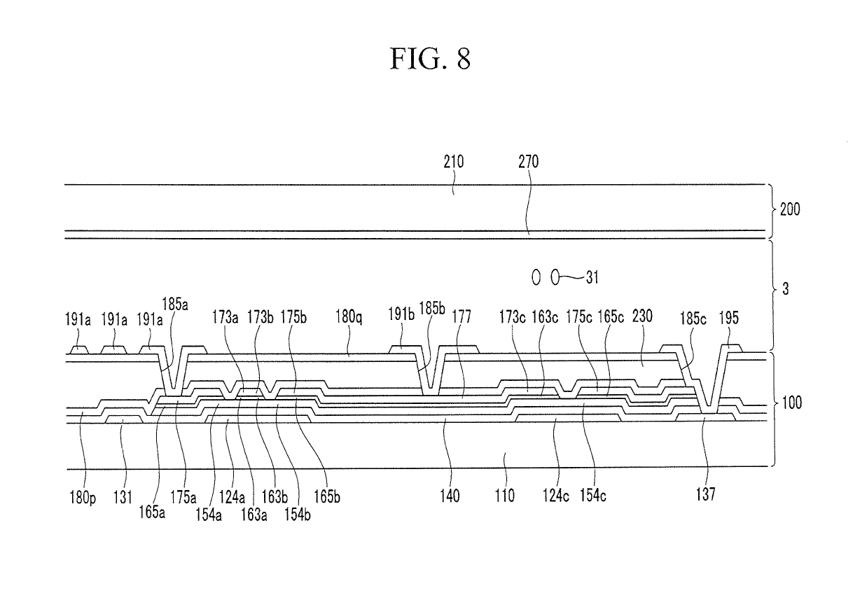

An example of the deposition structure of one pixel area of the lower panel will be described with reference to FIG. 7 and FIG. 8 along with FIG. 6.

FIG. 7 is a layout view of one pixel of a liquid crystal display according to an exemplary embodiment of the present invention. FIG. 8 is a cross-sectional view of the liquid crystal display of FIG. 7 taken along the line VII-VII.

A gate conductor including, for example, a gate line 121 and a divided voltage reference voltage line 131 is formed on an insulation substrate 110 formed of, for example, transparent glass, quartz or plastic. Further, in an exemplary embodiment, the insulation substrate 110 may be, for example, a flexible substrate. Suitable materials for the flexible substrate include, for example, polyethersulfone (PES), polyethylenenaphthalate (PEN), polyethylene (PE), polyimide (PI), polyvinyl chloride (PVC), polyethylene terephthalate (PET), or combinations thereof.

The gate line 121 includes, for example, a first gate electrode 124a, a second gate electrode 124b, a third gate electrode 124c, and a wide end for connection with another layer or an external driving circuit.

The divided voltage reference voltage line 131 includes, for example, first storage electrodes 135 and 136, and a reference electrode 137. Second storage electrodes 138 and 139 that are not connected to the divided voltage reference voltage line 131, but overlap a second subpixel electrode 191b, are also positioned.

A gate insulating layer 140 is formed on the gate line 121 and the divided voltage reference voltage line 131. For example, the gate insulating layer 140 may be made of silicon nitride (SiNx), silicon oxide (SiOx), silicon oxynitride (SiOxNy), aluminum oxide (AlOx), yttrium oxide (Y₂O₃), hafnium oxide (HfOx), zirconium oxide (ZrOx), aluminum nitride (AlN), aluminum oxynitride (AlNO), titanium oxide (TiOx), barium titanate (BaTiO3), lead titanate (PbTiO₃), or a combination thereof.

A first semiconductor 154a, a second semiconductor 154b, and a third semiconductor 154c are formed on the gate insulating layer 140. The first semiconductor 154a, the second semiconductor 154b, and the third semiconductor 154c, may be made of, for example, amorphous silicon (e.g. hydrogenated amorphous silicon). Alternatively, the first semiconductor 154a, the second semiconductor 154b, and the third semiconductor 154c may be formed of, for example, polysilicon, micro-crystal silicon, or single crystal silicon.

A plurality of ohmic contacts 163a, 165a, 163b, 165b, 163c, and 165c are formed on the semiconductors 154a, 154b, and 154c.

A data conductor including, for example, a plurality of data lines 171 including a first source electrode 173a and a second source electrode 173b, a first drain electrode 175a, a second drain electrode 175b, a third source electrode 173c, and a third drain electrode 175c is formed on the ohmic contacts 163a, 165a, 163b, 165b, 163c, and 165c and the gate insulating layer 140.

The data line 171 includes, for example, a wide end for connection with another layer or an external driving circuit.

The first gate electrode 124a, the first source electrode 173a, and the first drain electrode 175a form one first thin film transistor (TFT) Qa together with the first semiconductor 154a, and a channel of the thin film transistor is formed on the first semiconductor 154a between the first source electrode 173a and the first drain electrode 175a. Likewise, the second gate electrode 124b, the second source electrode 173b, and the second drain electrode 175b form one second thin film transistor Qb together with the second semiconductor 154b, and a channel is formed on the second semiconductor 154b between the second source electrode 173b and the second drain electrode 175b. In addition, the third gate electrode 124c, the third source electrode 173c, and the third drain electrode 175c form one third thin film transistor Qc together with the third semiconductor 154c, and a channel is formed on the third semiconductor 154c between the third source electrode 173c and the third drain electrode 175c.

The second drain electrode 175b is connected with the third source electrode 173c and includes, for example, an extension 177 which expands widely.

A first passivation layer 180p is formed on the data conductors 171, 173c, 175a, 175b, and 175c and the exposed portion of the first, second and third semiconductors 154a, 154b, and 154c. The first passivation layer 180p may include, for example, an inorganic insulating layer such as a silicon nitride or silicon oxide. The first passivation layer 180p prevents a pigment of a color filter 230 from flowing into the exposed portion of the first, second and third semiconductors 154a, 154b, and 154c.

The color filter 230 is formed on the first passivation layer 180p. The color filter 230 extends according to two adjacent data lines in the vertical direction.

A second passivation layer 180q is formed on the color filter 230.

The second passivation layer 180q may include, for example, an inorganic insulating layer made of a silicon nitride, a silicon oxide, or the like. The second passivation layer 180q prevents the color filter 230 from being lifted, and suppresses contamination of a liquid crystal layer 3 by an organic material such as, for example, a solvent flowing in from the color filter 230 to prevent defects such as an afterimage which may be caused when a screen is driven.

The first passivation layer 180p and the second passivation layer 180q have, for example, a first contact hole 185a and a second contact hole 185b exposing the first drain electrode 175a and the second drain electrode 175b.

The first passivation layer 180p, the second passivation layer 180q, and the gate insulating layer 140 have, for example, a third contact hole 185c exposing a portion of the reference electrode 137 and a portion of the third drain electrode 175c, and the third contact hole 185c is covered by a connecting member 195. The connecting member 195 electrically connects the reference electrode 137 and the third drain electrode 175c through the third contact hole 185c.

A plurality of pixel electrodes 191 are formed on the second passivation layer 180q. Each pixel electrode 191 includes, for example, a first subpixel electrode 191a and a second subpixel electrode 191b which are separated from each other with the gate line 121 therebetween to extend together in a column direction based on the gate line 121. For example, the pixel electrode 191 may be made of a transparent conductive material such as indium tin oxide (ITO), indium zinc oxide (IZO), aluminum zinc oxide (AZO), or cadmium tin oxide (CTO) or a reflective metal such as aluminum (Al), silver (Ag), chromium (Cr), copper (Cu), gold (Au), iron (Fe), titanium (Ti), tantalum (Ta), molybdenum (Mo), rubidium (Rb), tungsten (W) or an alloy thereof.

The first subpixel electrode 191a and the second subpixel electrode 191b are physically and electrically connected to the first drain electrode 175a and the second drain electrode 175b through the first contact hole 185a and the second contact hole 185b, thereby respectively receiving data voltages from the first drain electrode 175a and the second drain electrode 175b. In this case, a part of the data voltage applied to the second drain electrode 175b is divided through the third source electrode 173c, and as a result, the magnitude of the voltage applied to the first subpixel electrode 191a is larger than the magnitude of the voltage applied to the second subpixel electrode 191b.

The first subpixel electrode 191a and the second subpixel electrode 191b to which the data voltages are applied generate an electric field together with a common electrode 270 of the upper mother substrate 200 to determine directions of the liquid crystal molecules 31 of the liquid crystal layer 3 between the two electrodes 191 and 270. Luminance of light passing through the liquid crystal layer 3 varies according to the determined directions of the liquid crystal molecules 31.

A lower alignment layer is positioned on the pixel electrode 191. The lower alignment layer may be a vertical alignment layer or a horizontal alignment layer. The lower alignment layer may include, for example, an alignment supplement agent to initially align the liquid crystal. For example, in an embodiment, the alignment supplement agent may be a reactive monomer, and may include an ultraviolet ray hardening monomer. The lower alignment layer may also include, for example, an ultraviolet ray hardening initiator. The ultraviolet ray hardening monomer may be, for example, an acrylate-based monomer, and the ultraviolet ray hardening initiator is made of a material to be absorbed in the ultraviolet ray region. For example, in an embodiment, the ultraviolet ray hardening initiator may be, for example, 2,2-dimethoxy-1,2-diphenyl ethanone.

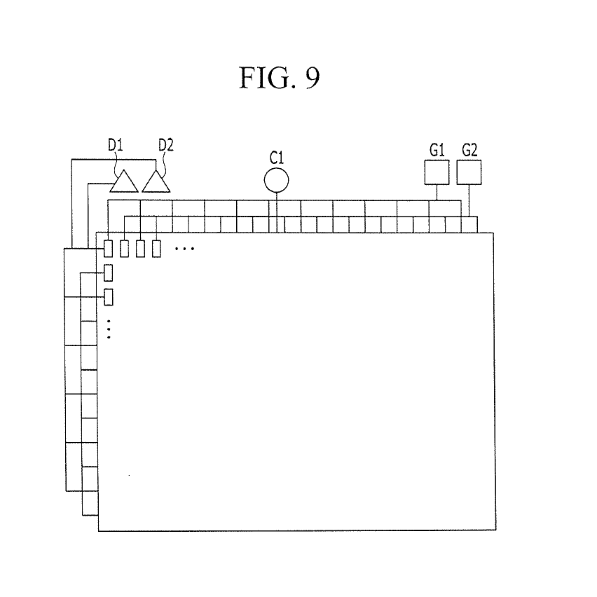

A plurality of pixels having the above-described deposition structure are formed in the lower panel 300. FIG. 9 is a view showing a connection relationship of the gate line, the data line, and the divided voltage reference voltage line of each pixel in one lower panel 300 of the mother substrate assembly according to an exemplary embodiment of the present invention.

Referring to FIG. 9, the gate line, the data line, and the divided voltage reference voltage line of each pixel extend outside the pixel and are gathered at one side.

Referring to FIG. 9, the gate lines connected to each pixel extend outside the pixel, are connected to each other at one side of the lower panel 300, and are connected to the gate driving lines G1 and G2. At this time, the adjacent pixels may be respectively connected to different gate driving lines G1 and G2. For example, the odd-numbered pixels may be connected to the gate driving line G1 and the even-numbered pixels may be connected to the gate driving line G2. The connection method is only one example, and if necessary, the gate line of each pixel may be connected to one gate driving line.

The data lines respectively connected to the pixels extend outside the pixel, are connected to each other at one side of the lower panel 300, and are connected to the data driving lines D1 and D2. At this time, the adjacent pixels may be respectively connected to the different data driving lines D1 and D2. For example, the odd-numbered pixels may be connected to the data driving line D1 and the even-numbered pixels may be connected to the data driving line D2. The connection method is only one example, and if necessary, the data line of each pixel may be connected to one data driving line.

The divided voltage reference voltage lines respectively connected to the pixels extend outside the pixel are connected to each other at one side of the lower panel, and are connected to the divided voltage reference voltage driving line C1.

The expansions of the gate driving lines G1 and G2, the data driving lines D1 and D2, and the divided voltage reference voltage driving line C1 formed at one side of the lower panel 300 may be formed at the same side surface of the lower panel 300. The expansions of the gate driving lines G1 and G2, the data driving lines D1 and D2, and the divided voltage reference voltage driving line C1 are formed on the lower mother substrate 100 outside the lower panel 300, and are cut and removed in a process of respectively cutting the display panel into each liquid crystal panel.

FIG. 4 shows the lower mother substrate of the mother substrate assembly according to an exemplary embodiment of the present invention.

Referring to FIG. 4, one lower panel 300 of the lower mother substrate may be separated into, for example, regions A1, A2, and A3 divided by cutting lines L1, L2, and L3 formed at the upper mother substrate 200 in a following step among the manufacturing process of the liquid crystal display.

The expansion of the gate driving lines G1 and G2, the expansion of the data driving lines D1 and D2, and the expansion of the divided voltage reference voltage driving line C1 are formed in the region A1 of FIG. 4. The gate driving lines G1 and G2, the data driving lines D1 and D2, and the divided voltage reference voltage driving line C1 are connected inside the lower panel 300, and an inner portion of the lower panel 300 is indicated by a dotted line. That is, as described above, each gate driving line G1 and G2 is connected to the gate line of each pixel in the lower panel, the data driving lines D1 and D2 are connected to the data line of each pixel, and the divided voltage reference voltage driving line C1 is connected to the divided voltage reference voltage line RL of each pixel.

A short spacer 70 for shorting with the upper mother substrate 200 is formed on the expansions of the gate driving lines G1 and G2 and the data driving lines D1 and D2 formed in the region A1. The short spacer 70 contacts the upper mother substrate 200, and the gate driving lines G1 and G2 and the data driving lines D1 and D2. When the upper mother substrate 200 is applied with the voltage later, the voltage is applied through the short spacer 70 and is transmitted to the gate line and the data line of each pixel.

However, the short spacer 70 is not formed on the divided voltage reference voltage driving line C1 formed in the region A1. Accordingly, when the voltage is applied to the upper mother substrate 200 of the region A1, the divided voltage reference voltage driving line C1 is not applied with the voltage.

Next, a shape of the gate driving lines G1 and G2, the divided voltage reference voltage driving line C1, and the data driving lines D1 and D2 in the region A2 of FIG. 4 will be described.

In the region A2, one gate driving line G2 has, for example, an additional expansion. The additional expansion of the gate driving line G2 is connected to the gate driving line G2 by a resistor R2. A short spacer 71 for contact with the upper mother substrate 200 is formed on the additional expansion of the gate driving line G2.

Likewise, one data driving line D1 has, for example, an additional expansion. The additional expansion of the data driving line D1 is connected to the data driving line D1 by the resistor R2. The short spacer 71 for contact with the upper mother substrate 200 is formed at the additional expansion of the data driving line D1.

In the region A2, the divided voltage reference voltage driving line C1 formed at the lower mother substrate 100 has, for example, an additional expansion. The short spacer 72 is formed on the additional expansion of the divided voltage reference voltage driving line C1. The divided voltage reference voltage driving line C1 is supplied with the voltage when the voltage is applied to the region A2 of the upper mother substrate 200 thorough the short spacer 72.

In an exemplary embodiment of the present invention, the resistor R2 formed in the region A2 may be formed of, for example, indium zinc oxide 190. FIG. 5 shows an enlarged region A portion indicated by the dotted line in FIG. 4. Referring to FIGS. 4-5, the gate driving line G2 and the expansion of the gate driving line G2 of the region A2 are connected by resistor R2 formed of the indium zinc oxide 190. Likewise, the data driving line D1 and the expansion of the data driving line D1 of the region A2 are connected by the resistor R2 formed of the indium zinc oxide 190. The indium zinc oxide 190 is formed of a different material from a material of the gate driving line and the data driving line, and has higher resistance than the gate driving line and the data driving line thereby functioning as the resistor R2. Alternatively, in an exemplary embodiment of the present invention, the resistor R2 may be formed of a different material than indium zinc oxide 190.

An upper mother substrate 200 including an upper panel corresponding to the lower panel and coated with an upper alignment layer is then provided. Next, referring to FIG. 3A and FIG. 3B, the upper mother substrate will be described. The upper mother substrate 200 includes, for example, a plurality of upper panels 310 respectively corresponding to the lower panel 300 and arranged in an approximate matrix shape.

The upper panel 310 includes, for example, a plurality of pixel areas respectively corresponding to a plurality of pixel areas of the lower panel 300. The pixel area of the lower panel 300 and the pixel area of the upper panel 310 corresponding to each other form one pixel PX as a unit displaying an image together.

The upper mother substrate 200 may include, for example, an insulation substrate, a common electrode formed on the insulation substrate, and an upper alignment layer formed on the common electrode. The upper alignment layer may be a vertical alignment layer or a horizontal alignment layer. The upper alignment layer may include, for example, an alignment supplement agent to initially align the liquid crystal. For example, the alignment supplement agent may be a reactive monomer, and may include a ultraviolet ray hardening monomer. The lower alignment layer may also include, for example, a ultraviolet ray hardening initiator. The ultraviolet ray hardening monomer may be, for example, an acrylate-based monomer, and the ultraviolet ray hardening initiator is made of a material to be absorbed in the ultraviolet rays region. For example, in an embodiment, the ultraviolet ray hardening initiator may be 2,2-dimethoxy-1,2-diphenyl ethanone.

The upper mother substrate 200 is larger than the lower mother substrate 100. Referring to FIG. 1, FIG. 3A, and FIG. 3B, as the upper mother substrate 200 is larger than the lower mother substrate 100, a region of the upper mother substrate 200 that does not face the lower mother substrate 100 is indicated by K1. The region K1 may only exist at one side among four side surfaces of the upper mother substrate 200, above and below, or all four surfaces.

Referring to FIG. 3B, the upper mother substrate 200 may be separated by the regions A1, A2, and A3 divided by the cutting lines L1, L2, and L3 formed at the upper mother substrate. The regions A1 and A3 may include, for example, voltage application portions P1 and P2 formed at one end of the region K1 where the upper mother substrate 200 does not face the lower mother substrate 100. In the following step, the voltage may be applied to the region A1 of the upper mother substrate 200 through the voltage application portion P1 and the region A3 of the upper mother substrate 200 through the voltage application portion P2. However, the upper mother substrate 200 may not include the voltage application portions P1 and P2, and the voltage may be directly applied to the upper mother substrate 200 without the voltage application portions P1 and P2.

Next, a liquid crystal mixture layer including the liquid crystal is formed between the upper mother substrate 200 and the lower mother substrate 100, and the upper mother substrate 200 and the lower mother substrate 100 are combined thereby forming the mother substrate assembly.

The liquid crystal may have dielectric anisotropy. The liquid crystal mixture may further include, for example, an alignment supplement agent. For example, the alignment supplement agent may be a reactive monomer, and may include an ultraviolet ray hardening monomer. The liquid crystal mixture may also include, for example, a ultraviolet ray hardening initiator. The ultraviolet ray hardening monomer may be, for example, an acrylate-based monomer, and the ultraviolet ray hardening initiator is made of a material to be absorbed in the ultraviolet ray region. For example, the ultraviolet ray hardening initiator may be 2,2-dimethoxy-1,2-diphenyl ethanone.

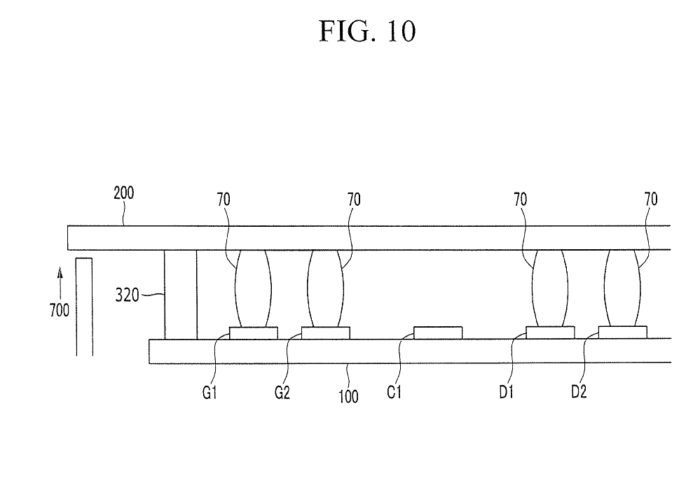

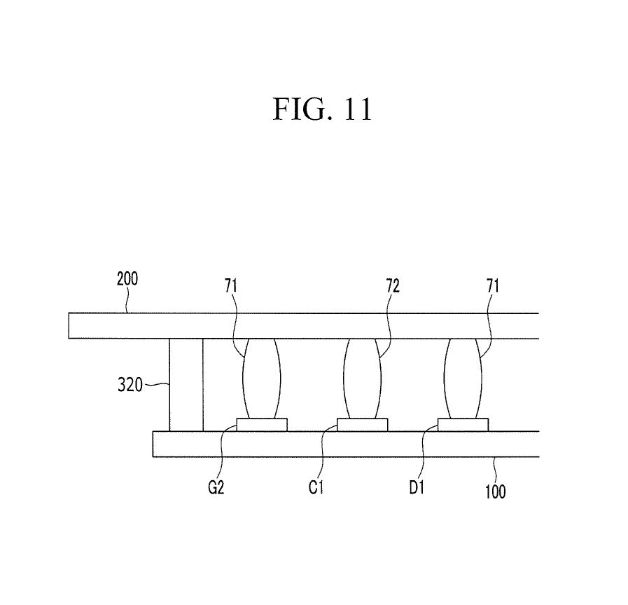

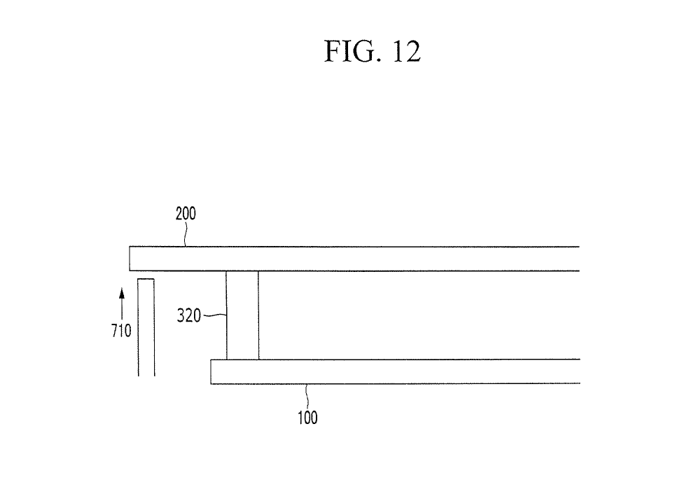

FIG. 10 is a cross-sectional view of the mother substrate assembly of FIG. 1 taken along the line IX-IX. FIG. 11 is a cross-sectional view of the mother substrate assembly of FIG. 1 taken along the line X-X. FIG. 12 is a cross-sectional view of the mother substrate assembly of FIG. 1 taken along the line XI-XI.

Referring to FIG. 10 to FIG. 12, the upper mother substrate 200 and the lower mother substrate 100 are sealed by a sealant 320, and as the upper mother substrate 200 is larger than the lower mother substrate 100, a portion of the upper mother substrate 200 does not correspond to the lower mother substrate 100 and is exposed. That is, the portion of the upper mother substrate 200 is positioned outside the formation of the sealant 320. The short spacers 70, 71, and 72 formed on the expansions of the gate driving lines G1 and G2, the data driving lines D1 and D2, and the divided voltage reference voltage driving line C1 of the lower mother substrate 100 contact the expansions of the gate driving lines G1 and G2, the data driving lines D1 and D2, and the divided voltage reference voltage driving line C1, as well as the upper mother substrate 200.

Referring to FIG. 10, in the region A1 of the mother substrate assembly, the gate driving lines G1 and G2 and the data driving lines D1 and D2 on the lower mother substrate 100 are connected to the upper mother substrate 200 through the short spacer 70.

Referring to FIG. 11, in the region A2 of the mother substrate assembly, the gate driving line G2 and the data driving line D1 on the lower mother substrate 100 are connected to the upper mother substrate 200 through the short spacer 71, and the divided voltage reference voltage driving line C1 is connected to the upper mother substrate 200 through the short spacer 72.

Referring to FIG. 12, in the region A3 of the mother substrate assembly, the short spacers 70, 71 and 72 do not exist between the lower mother substrate 100 and the upper mother substrate 200, and accordingly, the lower mother substrate 100 and the upper mother substrate 200 are electrically and physically disconnected.

Next, the upper mother substrate 200 is cut to be divided into, for example, three regions for each upper panel 310. The division may be realized by cutting the upper mother substrate 200 with, for example, a laser. Alternatively, the upper mother substrate 200 may be cut by other methods.

Referring to FIG. 3B, the upper mother substrate 200 is divided by, for example, three cutting lines L1, L2, and L3 for each upper panel 310. The first cutting line L1, the second cutting line L2, and the third cutting line L3 are sequentially positioned. The first cutting line L1 is positioned at one edge inside the upper panel 310, and the second cutting line L2 is positioned more inside the upper panel 310 than the first cutting line L1. The third cutting line L3 is positioned outside the upper panel 310, and has a function of separating each upper panel 310 from the adjacent display panel.

One upper panel 310 of the upper mother substrate 200 is divided into, for example, three regions by the first cutting line L1, the second cutting line L2, and the third cutting line L3. The region between an outermost edge (or the neighboring third cutting line L3) of the upper mother substrate 200 and the first cutting line L1 is indicated by A1, the region between the first cutting line L1 and the second cutting line L2 is indicated by A2, and the region between the second cutting line L2 and the third cutting line L3 is indicated by A3.

The portion of the upper panel 310 and the voltage application portion P1 may be formed at the upper mother substrate 200 in the region A1. As described above, the portion of the lower panel 300, the gate driving lines G1 and G2 and the expansion thereof, the data driving lines D1 and D2 and the expansion thereof, and the divided voltage reference voltage driving line C1 and the expansion thereof are formed at the lower mother substrate 100 in the region A1. The short spacer 70 is formed at the expansion of the gate driving lines G1 and G2 and at the expansion of the data driving lines D1 and D2 to be connected with the upper mother substrate 200.

The portion of the upper panel 310 is formed at the upper mother substrate 200 in the region A2. The additional expansion of the gate driving line G2, the resistor R2 connecting the gate driving line G2 and the additional expansion, the additional expansion of the data driving line D1, the resistor R2 connecting the data driving line D1 and the additional expansion, and the additional expansion of the divided voltage reference voltage driving line C1 are formed at the lower mother substrate 100 in the region A2. The short spacer 71 is formed on the additional expansion of the gate driving line G2 and the data driving line D1 to be connected with the upper mother substrate 200. Also, the short spacer 72 is formed on the additional expansion of the divided voltage reference voltage driving line C1 to be connected with the upper mother substrate 200.

The region A3 has a widest area among the three regions A1-A3, and most of the area of the upper panel 310 is occupied by the region A3 at the upper mother substrate 200. The voltage application portion P2 may be positioned in the region A3 at the edge of the upper mother substrate 200. The gate driving lines G1 and G2, the data driving lines D1 and D2, and the divided voltage reference voltage driving line C1 are formed at the lower mother substrate 100 at the region A3. The gate driving lines G1 and G2 are connected to the gate line of each pixel of the lower panel 300, the data driving lines D1 and D2 are connected to the data line, and the divided voltage reference voltage driving line C1 is connected to the divided voltage reference voltage line.

Next, a voltage for a liquid crystal pretilt is applied to the end of the upper mother substrate 200 through, for example, a voltage application probe. At this time, the applied voltage may be, for example, different for each region divided from the upper mother substrate 200.

Referring to FIG. 1 and FIG. 4, the voltage for the liquid crystal pretilt may be applied through the voltage application portion P1 of the region A1 and the voltage application portion P2 of the region A3 by using the voltage application probe. Alternatively, the voltage may be, for example, directly applied to the upper mother substrate 200 without the voltage application portions P1 and P2.

In this step, the voltage is only applied to the region A1 and the region A3, and the voltage is not applied to the region A2. The regions A1, A2, and A3 are electrically and physically disconnected through the cutting of the previous step, as described above.

The magnitudes of the voltages applied to the region A1 and the region A3 may be, for example, different. For example, the voltage applied to the region A1 may be a ground voltage 0 V and the voltage applied to the region A3 may be a voltage that is larger than the 0 V, such as for example, about 9.5 V.

The ground voltage applied to the region A1 is transmitted according to the upper mother substrate 200. Referring to FIG. 10, when the voltage is applied to the upper mother substrate 200 through the voltage application probe 700, the applied voltage is transmitted to the gate driving lines G1 and G2 and the data driving lines D1 and D2 on the lower mother substrate 100 through the short spacer 70 connecting the upper mother substrate 200 and the lower mother substrate 100.

The voltage is not applied from the outside to the upper mother substrate 200 of the region A2 by the voltage application probe 700. However, referring to FIG. 5 and FIG. 11, in the region A1, the gate driving line G2 and the data driving line D1 receiving the voltage from the upper mother substrate 200 have the expansion in the region A2. In the region A1, the gate driving line G2 receiving the voltage from the upper mother substrate 200 is connected to the expansion through the resistor R2 in the region A2, and transmits the voltage to the expansion. At this time, the transmitted voltage is different from the voltage transmitted from the upper mother substrate 200 due to the resistor R2. The expansion of the gate driving line G2 receiving the voltage is connected with the upper mother substrate 200 through the short spacer 71, and the voltage is transmitted to the upper mother substrate 200 through the short spacer 71.

Likewise, the data driving line D1 supplied with the voltage from the upper mother substrate 200 in the region A1 is connected to the expansion through the resistor R2 in the region A2, and transmits the voltage to the expansion. At this time, the transmitted voltage is different from the voltage transmitted from the upper mother substrate 200 due to the resistor R2. The expansion of the data driving line D1 receiving the voltage transmits the voltage to the upper mother substrate 200 through the short spacer 71.

The divided voltage reference voltage driving line C1 of the region A2 has the additional expansion in the region A2, and the short spacer 72 connected with the upper mother substrate 200 is formed on the additional expansion of the divided voltage reference voltage driving line C1 in the region A2. The voltage transmitted to the upper mother substrate 200 through the short spacer 71 of the gate driving line G2 and the data driving line D1 is transmitted to the divided voltage reference voltage driving line C1 through the short spacer 72 formed at the additional expansion of the divided voltage reference voltage driving line C1 in the region A2. Accordingly, the divided voltage reference voltage driving line C1 receives the voltage applied to the upper mother substrate 200 through the short spacer 71 of the gate driving line G2 and the data driving line D1 in the region A2. At this time, the transmitted voltage passes through the resistor R2 such that it is different from the voltage that is initially applied to the region A1.

The voltage applied to the region A3 is transmitted to a common electrode of each upper panel of the upper mother substrate 200.

The gate driving lines G1 and G2, the data driving lines D1 and D2, and the divided voltage reference voltage driving line C1 passing through the regions A1 and A2 are connected to the gate line, the data line, and the divided voltage reference voltage line of each pixel of the lower panel 300 to transmit the voltage.

FIG. 2 is an equivalent circuit diagram of one pixel of an exemplary embodiment of the present invention. A gate line GL and a data line DL of the circuit diagram are connected to the gate driving line G1 and the data driving line D1 to receive the ground voltage. Further, the divided voltage reference voltage line RL is also connected to the divided voltage reference voltage driving line C1 to receive the voltage.

In the present exemplary embodiment of the present invention, the upper mother substrate 200 is cut into, for example, three regions, and the short spacer 71 of the gate driving line G2 and the data driving line D1, the resistor R2, and the short spacer 72 of the divided voltage reference voltage driving line C1 are formed at the lower mother substrate 100 corresponding to the region A2, to apply the voltage to the divided voltage reference voltage driving line C1. At this time, the voltage applied to the divided voltage reference voltage driving line C1 becomes a third voltage that is different from the voltage applied to the region A1 and the voltage applied to the region A3. This is the because the voltage applied to the divided voltage reference voltage driving line C1 passes from the region A2 to the resistor R2.

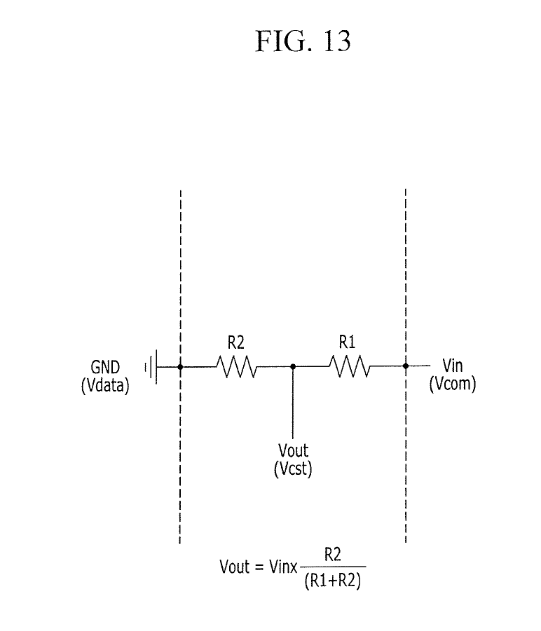

FIG. 13 is a circuit diagram of a voltage applied to a divided voltage reference voltage line. Referring to FIG. 13, the data line and the gate line are applied with the voltages GND and Vdata. Also, the common electrode is applied with voltages Vin and Vcom. The liquid crystal between the lower panel and the upper panel is aligned by a voltage difference. R2 is the resistor formed at the region A2. By the resistor R2, in the present exemplary embodiment of the present invention, a magnitude Vout (Vcst) of the voltage applied to the divided voltage reference voltage line may be expressed by, for example, the equation below.

Vₒᵤₜ=Vᵢₙ*(R₂/(R₁+R₂)

Referring to FIG. 2, as the gate line and the data line are supplied with the same ground voltage and the common electrode is supplied with a predetermined voltage, if the divided voltage storage electrode line is not applied with a separate voltage, the same electric field is formed to the first sub-pixel electrode region PEa and the second sub-pixel electrode region PEb. However, in the present exemplary embodiment of the present invention, the divided voltage storage electrode line is supplied with a separate voltage such that the first sub-pixel electrode region PEa and the second sub-pixel electrode region PEb have the voltage difference for the common electrode. Accordingly, in one pixel, the different electric fields may be formed for the first sub-pixel electrode region PEa and the second sub-pixel electrode region PEb.

That is, in the present exemplary embodiment of the present invention, three output voltages are formed from two input voltages P1 and P2. One output voltage is applied to the region A1 and is the ground voltage that is applied to the gate line and the data line of the pixel, and another output voltage is applied to the region A3 and is the voltage that is applied to the common electrode of the pixel. Also, another output voltage is the voltage that is changed while the input voltage applied to the region A1 passes through the resistor R2 and is applied to the divided voltage reference voltage line.

As three output voltages are applied to the pixel, the different electric fields are formed for the first sub-pixel electrode region PEa and the second sub-pixel electrode region PEb of each pixel.

Next, light is irradiated on the upper mother substrate 200 to harden the alignment supplement agent.

When the alignment supplement agent is the ultraviolet ray hardening monomer, the light such as ultraviolet rays may be irradiated to the liquid crystal layer to harden the alignment supplement agent. As described above, the alignment supplement agent may be included in at least one of the lower alignment layer and the upper alignment layer. Also, the alignment supplement agent may be included in the liquid crystal mixture layer between the upper panel and the lower panel.

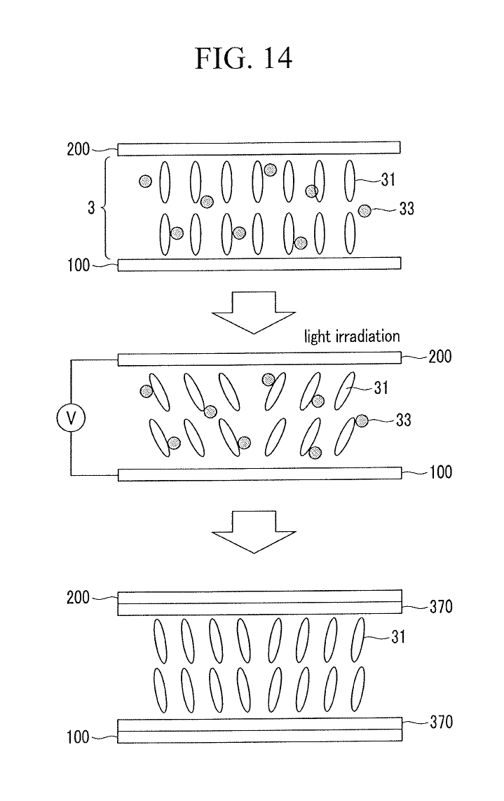

FIG. 14 is a view of a step of applying a voltage (V) and irradiating light in a manufacturing process of a liquid crystal display according to an exemplary embodiment of the present invention. Referring to FIG. 14, the liquid crystal molecules are aligned to have a predetermined pretilt by the application of the voltage, and the light is then irradiated to form the pretilt in the aligned state. At this time, the pretilt may be maintained while the alignment supplement agent is hardened.

The electric field is formed to the liquid crystal layer by the voltage (V) that is applied in the previous step. As described above, the present exemplary embodiment of the present invention forms two input voltages into three output voltages such that the electric field is different for the first sub-pixel electrode and the second sub-pixel electrode region because of the three output voltages. When displaying the image, the voltage of the divided voltage reference voltage line is not applied to the region of the first sub-pixel electrode that is recognized with further higher luminance such that the electric field is largely formed. However, the voltage of the divided voltage reference voltage line is applied to the region of the second sub-pixel electrode that is recognized with further lower luminance such that the difference of the voltage applied to the common electrode is small. Accordingly, the electric field is small compared with the first sub-pixel electrode region.

Accordingly, in the state that the voltage (V) is applied according to an exemplary embodiment of the present invention, the alignment state of the liquid crystal is different in the first sub-pixel electrode region and the second sub-pixel electrode region. In this state, when hardening the alignment supplement agent by irradiating the light in the upper mother substrate 200, the pretilt degree of the liquid crystal is different in the first sub-pixel electrode region and the second sub-pixel electrode region. That is, the pretilt degree of the liquid crystal in the region of the first sub-pixel electrode where the larger electric field is formed is increased and the pretilt degree of the liquid crystal in the region of the second sub-pixel electrode where the smaller electric field is formed is decreased.

Accordingly, in the present exemplary embodiment of the present invention, by generating three output voltages through two input voltages, the pretilt of the liquid crystal is differently realized in the first sub-pixel electrode region and the second sub-pixel electrode region in each pixel.

In general, when applying two input voltages to the mother substrate assembly, it may be difficult to differently realize the voltages applied to the first sub-pixel electrode region and the second sub-pixel electrode region of each pixel. Accordingly, to differently form the pretilt of the liquid crystal in the first sub-pixel electrode region and the second sub-pixel electrode region, three input voltages are required However, the present exemplary embodiment of the present invention adds the cutting line to the upper mother substrate and the appropriate short spacer and resistor are used in the added cutting region, thereby differently realizing the electric field formed in the first sub-pixel electrode region and the second sub-pixel electrode region by generating three output voltages through two input voltages.

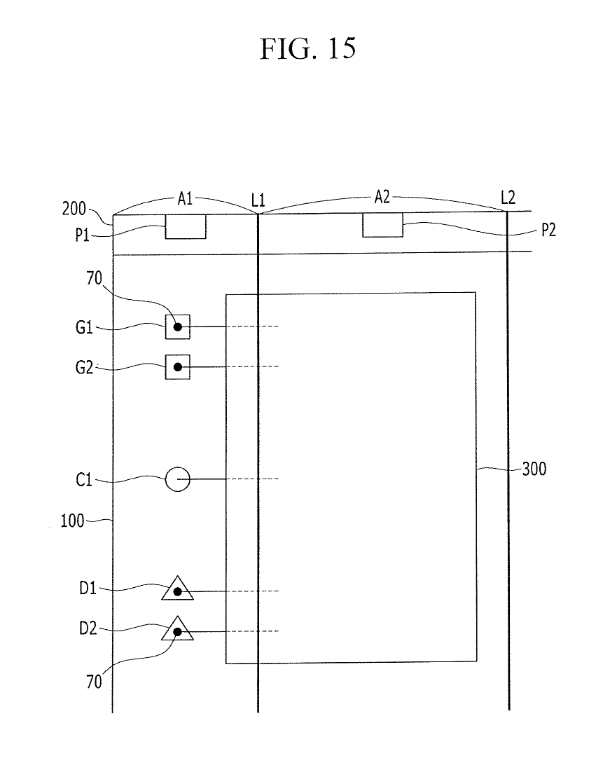

FIG. 15 is a top plan view of a liquid crystal display according to a comparative example. Referring to FIG. 15, two cutting lines L1 and L2 exist per upper panel 310 in the upper mother substrate 200, and the upper mother substrate 200 is divided into two regions A1 and A2. The ground voltage is applied to the voltage application portion P1 of the region A1, and the predetermined voltage of, for example, 9.5 V, is applied to the voltage application portion P2 of the region A2. The voltage applied to the region A1 of the upper mother substrate 200 is applied to the gate driving line and data driving line through the short spacer 70 on the expansion of the gate driving line G1 and G2 and the expansion of the data driving lines D1 and D2. The gate driving line is connected to the gate line of each pixel to transmit the voltage, and the data driving line is connected to the data line of each pixel to apply the voltage.

The voltage applied to the region A2 of the upper mother substrate 200 is transmitted to the common electrode of the upper mother substrate 200.

Accordingly, the ground voltage is applied to the gate line and data line of each pixel, and the common electrode is applied with the predetermined voltage (for example, 9.5 V), thereby forming the electric field to the liquid crystal layer. In the comparative example, the divided voltage reference voltage driving line C1 is not connected with the upper mother substrate 200 such that the voltage is not applied, and accordingly, the voltage is not applied to the divided voltage reference voltage line of the pixel. Therefore, in the comparative example, the electric field of the same magnitude is formed to the first sub-pixel electrode region and the second sub-pixel electrode region.

After applying the voltage, the light is irradiated to form the pretilt to the liquid crystal. At this time, the electric field of the first sub-pixel electrode region and the second sub-pixel electrode region by the application of the voltage is the same such that the pretilt degree of the liquid crystal is the same in the first sub-pixel electrode region and the second sub-pixel electrode region.

However, with exemplary embodiments of the present invention, by adding the cutting lines L1-L3 to the upper mother substrate 200 and using the appropriate short spacer 70 and resistor R2 in the added cutting region, the voltage is applied to the divided voltage reference voltage driving line C1 without the separate addition voltage application portion. That is, three output voltages are realized by two input voltages, and the voltage is also input to the divided voltage reference voltage line of each pixel such that the electric fields of the first sub-pixel electrode region and the second sub-pixel electrode region are differently formed. When applying the voltage to the mother substrate assembly, the electric field is differently generated to the first sub-pixel electrode region and the second sub-pixel electrode region, and in this state, when irradiating the light to the upper mother substrate 200, the pretilt degree for the liquid crystal is different. That is, the first sub-pixel electrode region is applied with the larger electric field such that the pretilt degree of the liquid crystal is larger and the second sub-pixel electrode region is applied with the smaller electric field, thereby the pretilt degree of the liquid crystal in the second sub-pixel electrode region is decreased compared to the pretilt degree of the liquid crystal in the first sub-pixel electrode region.

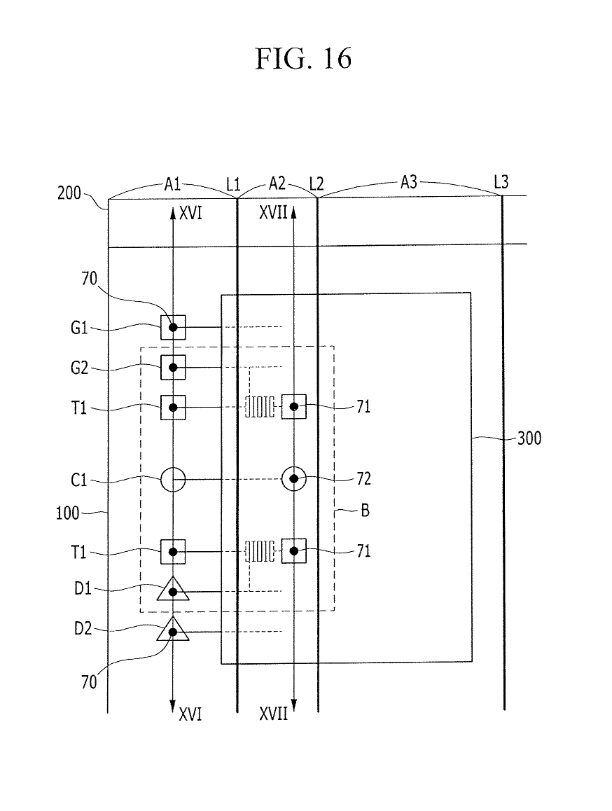

Next, a manufacturing method of a liquid crystal display according to an exemplary embodiment of the present invention will be described with reference to FIG. 16 to FIG. 19.

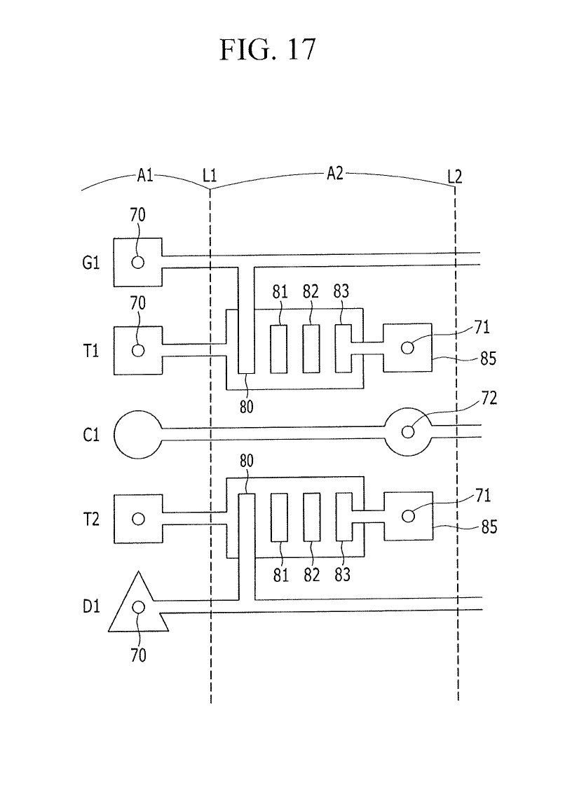

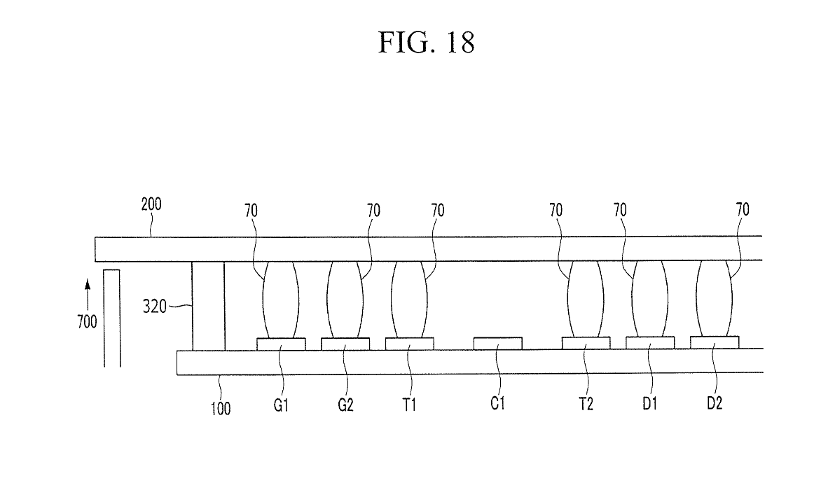

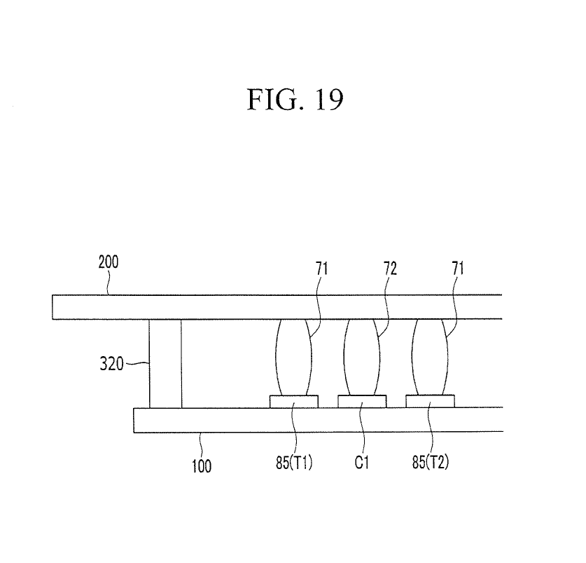

FIG. 16 is a top plan view of a mother substrate assembly to explain a manufacturing method of a liquid crystal display according to an exemplary embodiment of the present invention. FIG. 17 is an enlarged view of a region indicated by B in FIG. 16. FIG. 18 is a cross-sectional view of the mother substrate assembly of FIG. 16 taken along the line XVI-XVI. FIG. 19 is a cross-sectional view of the mother substrate assembly of FIG. 16 taken along the line XVII-XVII.

Referring to FIGS. 16 to 19, the manufacturing method of the liquid crystal display according to the present exemplary embodiment is similar to the manufacturing method of the liquid crystal display according to the described exemplary embodiment. The detailed description for the similar constituent elements is omitted.

However, the manufacturing method of the liquid crystal display according to the present exemplary embodiment is different from the manufacturing method of the liquid crystal display according to the described exemplary embodiment with regard to the shape of the resistor R2. In the exemplary embodiment according to FIG. 4 and FIG. 5, the resistor R2 is connected to the gate driving line G2 and the data driving line D1 and may be made of, for example, IZO, ITO, AZO, or CTO.

However, referring to FIGS. 16 and 17, in the manufacturing method of the liquid crystal display according to the present exemplary embodiment, the resistor R2 formed at the region A2 is formed of, for example, a plurality of transistors. Referring to FIG. 16, transistor gate lines T1 and T2 are additionally positioned between the gate driving lines G1 and G2, the data driving lines D1 and D2, and the divided voltage reference voltage driving line C1. The transistor gate lines T1 and T2 form the gate driving line G2, the data driving line D1, and the plurality of transistors in the region A2, and the plurality of transistors function as the resistor.

FIG. 17 is the enlarged view of the region B indicated by a dotted line of FIG. 16. Referring to FIG. 17, the transistor gate lines T1 and T2 are positioned between the gate driving line G2 and the divided voltage reference voltage driving line C1, and the data driving line D1 and the divided voltage reference voltage driving line C1. The transistor gate lines T1 and T2 may be formed of, for example, the same material as the gate line, and include the expansion for contact with the upper mother substrate 200 and the short spacer 70 on the expansion.

Referring to FIG. 17, in the region A2, the transistor gate line T1 forms the additional expansion in which a plurality of transistors are formed.

In the additional expansion, a branch line 80 of the gate driving line G2 divided from the gate driving line G2 is formed. A plurality of branch lines 81, 82, and 83 are, for example, parallel to the branch line 80 on the transistor gate line. In FIG. 17, four branch lines are shown, but exemplary embodiments of the present invention are not limited thereto but rather alternatively in exemplary embodiments more or less than four branch lines may be formed.

The branch line 83 that is formed at the farthest end of the transistor gate line additional expansion has an expansion 85 for contact with the upper mother substrate 200. The short spacer 71 contacting the upper mother substrate 200 and the branch line 83 is formed on the expansion.

The plurality of branch lines formed on the transistor gate line additional expansion form one transistor along with the neighboring branch line. The branch lines 80, 81, 82, and 83 may be made of, for example, the same material as the gate driving line, and the semiconductor may be formed between the adjacent branches. That is, the transistor gate line T1 and the branch lines 80, 81, 82, and 83 function as a plurality of transistors, and may include constituent elements for the function of the transistor, such as, for example, an insulating layer, an ohmic contact, and a semiconductor. As described above, a plurality of transistors formed at the region A2 function as the resistor R2.

Likewise, the transistor gate line T2 also forms the additional expansion in which a plurality of transistors are formed. In the additional expansion, the branch line 80 of the data driving line G2 divided from the data driving line D1 is formed. The plurality of branch lines 81, 82, and 83 parallel to the branch line 80 are positioned on the transistor gate line T2. In FIG. 15, four branch lines are shown but exemplary embodiments of the present invention are not limited thereto but rather alternatively in an exemplary embodiment more or less than four branch lines may be formed.

The branch line 83 formed at the farthest end of the transistor gate line additional expansion has the expansion 85 for contact with the upper mother substrate 200. The short spacer 71 contacting the upper mother substrate 200 and the branch line 83 are positioned on the expansion.

The plurality of branch lines formed on the transistor gate line additional expansion form one transistor along with the neighboring branch line. The branch lines 80, 81, 82, and 83 may be formed of, for example, the same material as the gate driving line and the data driving line, and the semiconductor may be formed between the neighboring branch lines. That is, the transistor gate line T1 and the branch lines 80, 81, 82, and 83 function as a plurality of transistors, and may include the constituent elements for the function of the transistor, such as, for example, an insulating layer, an ohmic contact, and a semiconductor. As described above, a plurality of transistors formed at the region A2 function as the resistor R2.

In the region A2, the divided voltage reference voltage driving line C1 includes, for example, an expansion for contact with the upper mother substrate 200, and the short spacer 72 is formed on the expansion to be connected with the upper mother substrate 200.

FIG. 18 is a cross-sectional view of the mother substrate assembly of FIG. 16 taken along the line XVI-XVI. Referring to FIG. 18, when applying the voltage to the upper mother substrate 200 by the voltage application probe 700, the gate driving lines G1 and G2, the data driving lines D1 and D2, and the transistor gate lines T1 and T2 receive the voltage from the upper mother substrate 200 through the short spacer 70.

Referring to FIG. 17, the applied voltage passes the plurality of transistors formed on the transistor gate lines T1 and T2, and the plurality of transistors function as the resistor such that the voltage is changed while passing the plurality of transistors.

FIG. 19 is the cross-sectional view of the mother substrate assembly of FIG. 16 taken along the line XVII-XVII. Referring to FIG. 19, the voltage that is changed through the plurality of transistors is transmitted to the upper mother substrate 200 of the region A2 through the short spacer 71 formed on the expansion 85 of the branch line 83 formed at the farthest end of the transistor gate line additional expansion.

The voltage transmitted to the region A2 of the upper mother substrate 200 through the short spacer 71 is transmitted to the divided voltage reference voltage driving line through the short spacer 72 formed at the expansion of the divided voltage reference voltage driving line. The divided voltage reference voltage driving line transmits the transmitted voltage to the divided voltage reference voltage line of each pixel.

The description of the light irradiation and the liquid crystal pretilt is the same as described above.

Accordingly, the manufacturing method of the liquid crystal display according to the present exemplary embodiment generates the three output voltages through two input voltage and forms the different electric fields for the first sub-pixel electrode region and the second sub-pixel electrode region of each pixel, thereby differently forming the pretilt of the liquid crystal in the first sub-pixel electrode region and the second sub-pixel electrode region of the pixel.

Next, the liquid crystal display according to an exemplary embodiment of the present invention will be described with reference to FIG. 4. The description related to the present invention liquid crystal display is similar to the description described in the manufacturing method of the liquid crystal display. The detailed description of similar constituent elements is omitted.

In an exemplary embodiment of the present invention, the liquid crystal display receives the voltage applied to the upper panel through the short spacer positioned on the gate driving line expansion, the data driving line expansion, and the divided voltage reference voltage driving line expansion positioned at the side surface of the lower panel.

Accordingly, the liquid crystal display according to an exemplary embodiment of the present invention has the gate driving line expansion, the data driving line expansion, and the divided voltage reference voltage driving line expansion formed at one side of the lower panel, and the short spacer is formed on the gate driving line expansion and the data driving line expansion.

Also, the short spacer is formed on the gate driving line expansion, the data driving line expansion, and the divided voltage reference voltage driving line expansion that are additionally formed inside the lower panel, and the resistor member is positioned between the gate driving line expansion and the gate driving line, and between the data driving line expansion and the data driving line.

The liquid crystal display according to an exemplary embodiment of the present invention may exist in a state in which the upper panel region and the lower panel region where the expansion of each driving line are formed are cut.

Having described exemplary embodiments of the present invention, it is further noted that it is readily apparent to those of ordinary skill in the art that various modifications may be made without departing from the spirit and scope of the invention which is defined by the metes and bounds of the appended claims.

What is claimed is:

1. A method manufacturing a liquid crystal display, comprising:
providing a lower mother substrate including a plurality of lower panels including a plurality of thin film transistors and coated with a lower alignment layer;
providing an upper mother substrate including a plurality of upper panels respectively corresponding to the plurality of lower panels and coated with an upper alignment layer;
forming a mother substrate assembly by forming a liquid crystal mixture layer including a liquid crystal between the lower mother substrate and the upper mother substrate and combining the lower mother substrate and the upper mother substrate;
dividing each upper panel into a first region, a second region, and a third region by forming three cutting lines for each upper panel at the upper mother substrate of the mother substrate assembly;
applying a voltage to the first region and the third region of the upper mother substrate that is not covered by the lower mother substrate and exposed to pretilt the liquid crystal; and
irradiating light to the mother substrate assembly at a side of the upper mother substrate to harden an alignment supplement agent included in at least one of the liquid crystal mixture layer and the lower and upper alignment layers.

2. The method of claim 1, wherein the lower panel includes a plurality of pixels, a gate driving line connected to a gate line of each pixel, a data driving line connected to a data line, and a divided voltage reference voltage driving line connected to a divided voltage reference voltage line.

3. The method of claim 2, wherein two gate driving lines exist per lower panel, each gate driving line is alternately connected to neighboring pixels,
wherein two data driving lines exist per lower panel, and each data driving line is alternately connected to the neighboring pixels.

4. The method of claim 3, wherein the gate driving line and the data driving line respectably have an expansion formed at the same side surface outside the lower panel, and
a short spacer formed on the gate driving line expansion and the data driving line expansion.

5. The method of claim 4, wherein in the lower mother substrate region corresponding to the second region of the upper mother substrate, one gate driving line, one data driving line, and the divided voltage reference voltage driving line respectively have the expansion, and
the short spacer is formed on the gate driving line expansion, the data driving line expansion, and the divided voltage reference voltage driving line expansion.

6. The method of claim 5, wherein the gate driving line and the gate driving line expansion are connected by a resistance member, and the data driving line and the data driving line expansion are connected by a resistance member.

7. The method of claim 6, wherein the resistance member comprises indium zinc oxide.

8. The method of claim 6, wherein the resistance member comprises at least one transistor.

9. The method of claim 8, wherein the transistor includes a transistor gate line expansion formed at the lower mother substrate region corresponding to the second region of the upper mother substrate, and
a connected branch electrode and a divided branch electrode in the gate driving line and the data driving line.

10. The method of claim 9, wherein the transistor gate line includes a transistor gate line expansion formed at the lower mother substrate corresponding to the first region of the upper mother substrate, and
a short spacer formed on the transistor gate line expansion.

11. The method of claim 1, wherein the cutting of the upper mother substrate is performed with a laser.

12. The method of claim 1, wherein the voltage applied to the first region of the upper mother substrate is transmitted to the gate driving line and the data driving line through the short spacer formed at the lower mother substrate.

13. The method of claim 12, wherein a portion of the voltage transmitted to the gate driving line and the data driving line is changed through the resistance member, and
the changed voltage is transmitted to the divided voltage reference voltage driving line through the short spacer formed at the second region of the mother substrate assembly.

14. The method of claim 13, wherein the voltage applied to the third region of the upper mother substrate is only transmitted to a common electrode of the upper mother substrate.

15. The method of claim 14, wherein the voltage applied to the first region of the upper mother substrate is about a ground voltage of 0 V, and the voltage applied to the third region of the upper mother substrate is about 9.5 V.

16. The method of claim 1, wherein in the applying of the voltage to the first region and the third region of the upper mother substrate that is not covered by the lower mother substrate and exposed to pretilt the liquid crystal,
a pretilt degree of the liquid crystal in the first sub-pixel area and the second sub-pixel area of one pixel is different.

17. A liquid crystal display comprising:
a display panel comprising:
a first substrate;
a gate line and a divided voltage reference voltage line disposed on the first substrate and electrically disconnected from each other;
a gate insulating layer disposed on the gate line and the divided voltage reference voltage line;
a semiconductor layer disposed on the gate insulating layer;
a data line disposed on the semiconductor layer;
a passivation layer disposed on the data line;
a pixel electrode disposed on the passivation layer;
a second substrate facing the first substrate;
a common electrode disposed on the second substrate;
a divided voltage reference voltage line;
a divided voltage reference voltage driving line;
a gate driving line,
a data driving line, wherein the gate line, the divided voltage reference voltage line and the data line extend in one side of the first substrate to be respectively connected to the gate driving line, the divided voltage reference voltage driving line, and the data driving line;
an expansion disposed at ends of the gate driving line, the divided voltage reference voltage driving line, and the data driving line; and
a short spacer disposed on the expansion, and
wherein the short spacer is connected with the common electrode.

18. The liquid crystal display of claim 17, further comprising
an additional short spacer,
wherein the gate driving line, the divided voltage reference voltage driving line, and the data driving line respectively have an additional expansion inside the display panel, wherein the additional short spacer is disposed on the additional expansion,
and wherein the gate driving line and the additional expansion of the gate driving line are connected by the resistance member, and the data driving line and the additional expansion of the data driving line are connected by the resistance member.

19. The liquid crystal display of claim 18, wherein
the resistance member comprises indium zinc oxide.

20. The liquid crystal display of claim 19, wherein
the first substrate in which the gate line expansion and the additional expansion, the divided voltage reference voltage line expansion and the additional expansion, and the data line expansion and the additional expansion are positioned, and the region of the second substrate region corresponding thereto, are separated and removed.
